(19) United States
(12) Patent Application Publication
(10) Pub. No.: US 2018/0114283 A1
(43) Pub. Date: Apr. 26, 2018

(54) Systems and Methods for the Optimization of User Rate Charges

(71) Applicant: Open Access Technology International, Inc., Minneapolis, MN (US)

(72) Inventors: Sasan Mokhtari, Eden Prairie, MN (US); Ebrahim Vaahedi, Vancouver (CA); Khashayar Nodehi Fard Haghighi, Maple Grove, MN (US); Girish Thirukkurungudi Sekar, Hopkins, MN (US); Guillermo Irisarri, Plymouth, MN (US); David Heim, Minneapolis, MN (US); Long Duong, Maple Grove, MN (US); Ali Ipakchi, San Carlos, CA (US)

(73) Assignee: Open Access Technology International, Inc., Minneapolis, MN (US)

(21) Appl. No.: 15/790,763

(22) Filed: Oct. 23, 2017

Related U.S. Application Data
(60) Provisional application No. 62/411,289, filed on Oct. 21, 2016.

(51) Int. Cl. G06Q 50/06; G06Q 10/06; G06Q 10/04

(52) U.S. Cl. CPC G06Q 50/06; G06Q 10/04; G06Q 10/06312

(57) ABSTRACT

A process/method is provided, which facilitates resource optimization considering all dispatchable resources as well as user rate charges, which are rate charges comprised of a base rate plus an incremental excess fee associated with designated usage parameters. The proposed system and method may utilize inputs to construct a periodic load profile over varied periods of time. The disclosure relates to forming a periodic load profile over varied periods of time based upon considerations of short-term and long-term cost for uses within microgrids to create microgrid resource schedules that optimize usage of loads and generation resources within a microgrid for minimizing both short-term energy charges and long-term demand charges while increasing microgrid resource efficiencies.

### CROSS-REFERENCE TO RELATED APPLICATIONS

This application claims priority to U.S. Provisional patent application No. 62/411,289 filed Oct. 21, 2016, the entire content of which is hereby incorporated by reference.

### STATEMENT REGARDING FEDERALLY SPONSORED RESEARCH

Not Applicable.

### FIELD OF THE INVENTION

The present disclosure relates generally to resource optimization for a microgrid operation considering all dispatchable resources as well as utility energy and demand user rate charges. In particular, the present disclosure relates to construction of a resource optimization solution that combines long-term demand charges (e.g. monthly) together with short-term energy charges (e.g. 15 minutes) thus considering the total utility charges incurred in the optimization along with all the characteristics of other resources and loads in a microgrid.

### BACKGROUND OF THE INVENTION

Electric utilities normally charge two components for electricity use; energy charge component and the demand charge component. The energy use is calculated across a short time frame (often 15 minutes) during which overall usage is tracked, averaged and the demand level is established. While the charges for energy use are calculated based on actual consumption in the short time frames (e.g. 15 minutes), demand charges are calculated using the peak of the demand incurred during the month by comparing the demand of short time intervals during the whole month.

While solutions for economic optimization have been in use in the energy industry for many years, such typically consider only immediate or short-term energy costs when the typical demand charge covers an entire month. Many solutions for economic optimization are not organized or flexible enough to adapt to real-time fluctuations generation or demand due to many factors, such as increased consumer demand, loss of Variable Electric Resource (such as solar or wind power) generation, among or in combination with many other factors. In recent years, emerging technologies that offer optimal electricity generation peaks at different periodicities and times of day have entered into the retail generation market. Existing systems and methods of resource optimization have either been slow to respond with accurately modeled long-term and short-term optimization solutions that including the functionality of such emerging technologies or have completely failed to consider these technologies alongside traditional generation sources for cost reduction. If the demand is based on a high usage period, for example, while you are running an electric dryer, your demand penalty may be artificially high.

The current disclosure relates, in at least one embodiment, to the optimization of microgrid resources considering all dispatchable resources as well as user rate charges.

### BRIEF SUMMARY OF THE INVENTION

In general, this disclosure is directed toward resource optimization considering all dispatchable resources as well as user rate charges. In particular, the present disclosure relates to construction of an optimization solution that combines long-term demand charges (e.g. monthly) together with short-term energy charges (e.g. 15 minutes) thus considering the total utility charges incurred. The invention utilizes a special optimization formulation that considers both long-term and short-term costs to establish short-term control set points for all the resources.

The invention combines both demand and energy costs for a particular microgrid site across a day. The DOE defines the microgrid as “a group of interconnected loads and distributed energy resources within clearly defined electrical boundaries that acts as a single controllable entity with respect to the grid”.

The invention's systems and methods utilize an optimization formulation that optimizes resources and utility energy and demand charge rates. In some embodiments, microgrids can be managed in a way that (1) Minimizes the total cost of operation including utility energy and demand charges. Since demand Charge is determined based on a monthly interval and energy charge is determined based on short intervals (e.g. 20 minutes), this procedure combines the monthly optimization and short-term optimization by decomposing a month to days and then to short intervals by (1) At the beginning of each day (or every hour) run a day-ahead scheduled optimization (e.g. 24 hour with one hour intervals or 48 hours) using import cost without any demand charge and get the import schedule from this result. This step can be conducted every hour instead of once a day to improve forecasting accuracy, (2) Divide the import schedule into segments (roughly 10%), (3) Calculate the cost of import for each segment based on the method described in the previous section and insert them as the incremental cost curve. This calculation should include the on-peak/off-peak hour energy and demand charges accurately, (4) Abandon the incremental demand Import cost obtained in (3) using only import energy cost for the following two conditions of a) the load demand is less than the historical monthly peak capacity for the site and b) the load level is less than the actual peak demand incurred from the beginning of the month, (5) Conduct short term optimization scheduling and control (e.g. 12 5-minute intervals) continuously once per interval (e.g. 5 minutes) using the incremental cost obtained for energy and demand in (4), (6) deploy set point controls in the next interval, (7) Continue this process at the start of each day (or each hour depending on the design), and (8) If at the end of the month, reset the peak demand level to zero and go back to (1). The systems and methods of the present invention enable the microgrid operator to create microgrid resource schedules that optimize usage of inter-tie flows and distributed energy resources to achieve total minimum operational cost considering both short-term energy charges and long-term demand charges.

### BRIEF DESCRIPTION OF DRAWINGS

FIG. 1 is a diagram illustrating an example of how the components of the systems and methods may interact.

FIG. 2 is a flow chart depicting the general process by which the systems and methods may estimate Day Ahead forecasted load demanded by the microgrid.

FIG. 3 is a flow chart depicting the general process by which the systems and methods establish an incremental cost of import.

FIG. 4 is a flow chart depicting the general process by which the systems and methods determine applicability of incremental cost of import.

FIG. 5 is a flow chart illustrating an example of the general process by which the systems and methods apply the incremental cost of import to optimize system operation in a particular embodiment of the described invention.

FIG. 6 is a bar graph depicting the results of a usecase in which the resources have been optimized using the approach described in this invention.

### DETAILED DESCRIPTION OF THE INVENTION

While this invention may be embodied in many forms, there are specific embodiments of the invention described in detail herein. This description is an exemplification of the principles of the invention and is not intended to limit the invention to the particular embodiments illustrated.

In general, this disclosure is directed toward resource optimization for a microgrid considering all dispatchable resources as well as utility energy and demand user charge rate charges. In particular, the present disclosure relates to construction of an optimization solution that combines long-term demand charges (e.g. monthly) together with short-term energy charges (e.g. 15 minutes) thus minimizing the total utility charges incurred. The invention utilizes a special optimization formulation that considers both long-term and short-term costs to establish short-term control set points for all the resources.

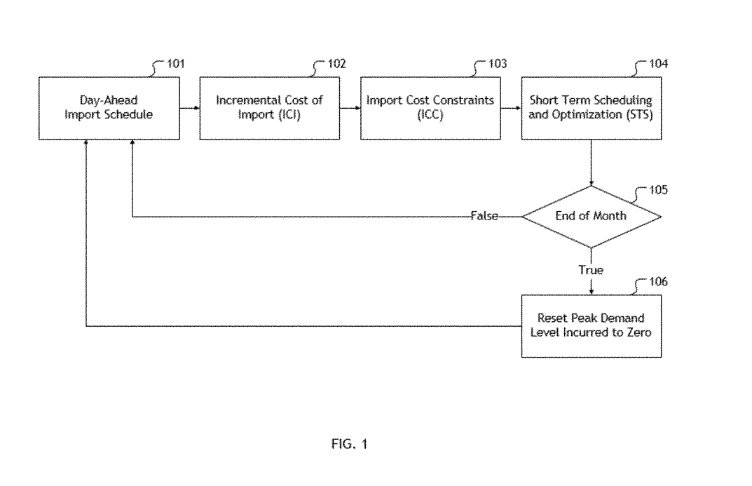

Referring to FIG. 1, which is a diagram illustrating an example of how the components of the systems and methods may interact, this procedure combines the monthly optimization and short-term optimization by measuring and decomposing a month to a Day-Ahead Import Schedule [101], developing an Incremental Cost of Import (ICI) [102], applying Import Cost Constraints (ICC) [103], conducting Short Term Scheduling, Optimization and Control (STS) [104], and resetting the Peak Demand Level Incurred to Zero at the end of the month.

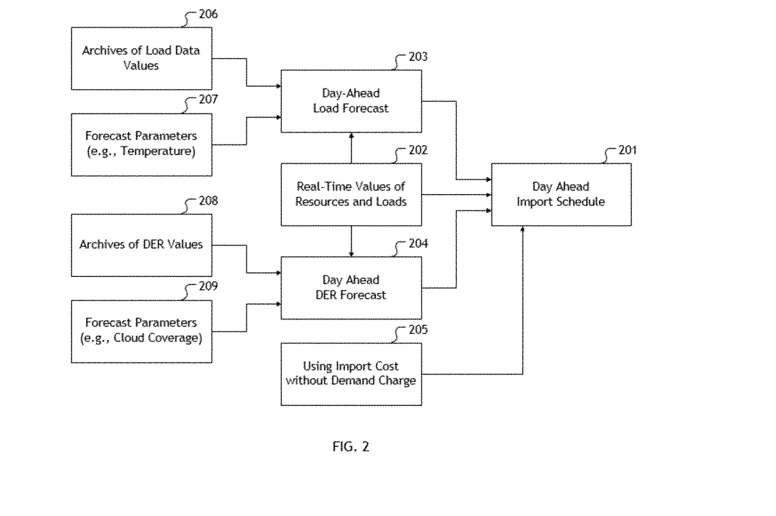

Referring to FIG. 2, which is a flow chart depicting the general process by which the systems and methods may estimate Day ahead forecasted load demanded by the microgrid and Day ahead Renewable forecast, Archives of Load Data Values [206] and Forecast Parameters [207] commonly known in the industry are utilized to determine a Day-Ahead Load Forecast [203]. Archives of Load Data Values [208] and Forecast Parameters [209] commonly known in the industry are utilized to determine a Day-Ahead DER Forecast [204]. Depending on the embodiment, the Real-Time Values of Resources and Loads, the Day-Ahead Load Forecast [203], the Day-Ahead DER Forecast [204], Import Cost without Demand Charge [205], or a combination thereof may be used to design a Day-Ahead Import Schedule [201].

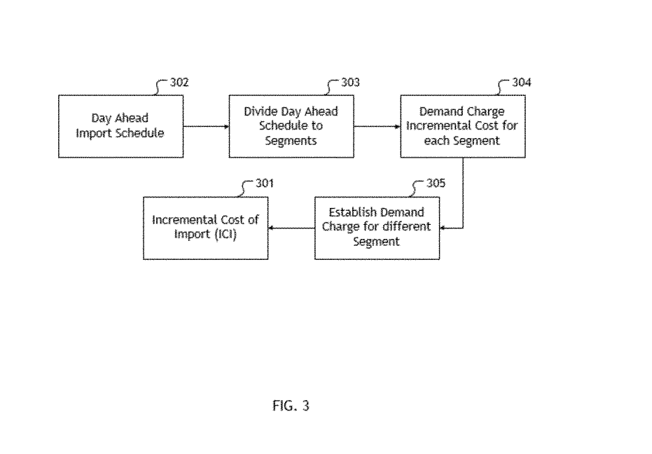

Referring to FIG. 3, which depicts the general process by which the invention establishes an incremental cost of import, the Day-Ahead Import Schedule determined in FIG. 2 can be divided into segments of defined load levels [303] to create a Demand Charge Incremental Cost for each Segment [304]. In some embodiments of the invention, the import schedule profile obtained may be divided into a number of segments, such as though not necessarily limited to a range of 10-100 segments; each representing 10% to 1% of the total profile respectively. While increasing the number of segments will improve the accuracy of incremental Import Cost calculation, it will also increase the computation need of the method. Preferred embodiments of the inventive systems and methods utilize 10 segments, each representing 10% of the import schedule profile. Considering the number of hours in every month that the load falls within each segment, the invention will establish a Demand Charge for a particular segment. Plotting the Demand Charge Incremental Cost for each Segment [304] against the Establish Demand or load levels for different Segment [305], the resulting curve is the Incremental Cost of Import [301].

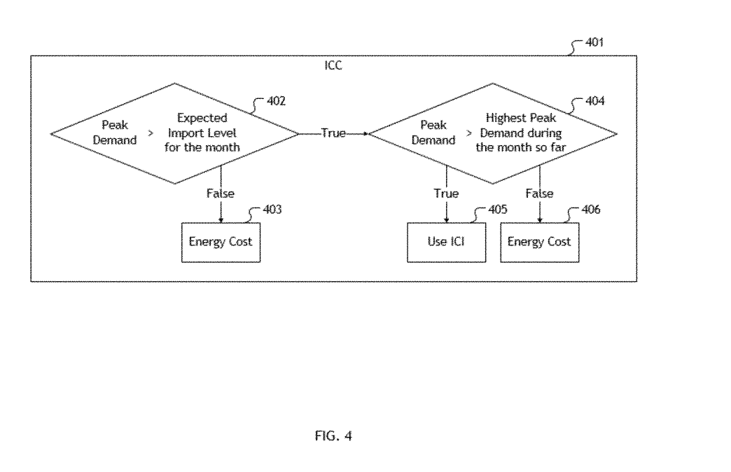

Referring to FIG. 4, which is a flow chart depicting the general process by which the systems and methods determine applicability of Incremental Cost of Import (ICI) [301]. The applicability of the ICI is determined by a sequence of Import Cost Constraints [401]. If the Peak Demand measured in the current period is smaller than the Import Level from the expected historical data, then import cost should use only the Energy Cost [403]. However, if the Peak Demand is higher, it shall be compared against the Highest Peak Demand during the month so far [404]. If it is lower than the Highest Peak Demand During the Month so far, the import cost should only use the Energy Cost component [406]. If the Peak Demand measured in the current period is yet higher than the Highest Peak Demand during the month so far, the ICI is the optimal solution [405]. In some embodiments, this will optimize the total cost of operation considering energy import energy and demand user rates.

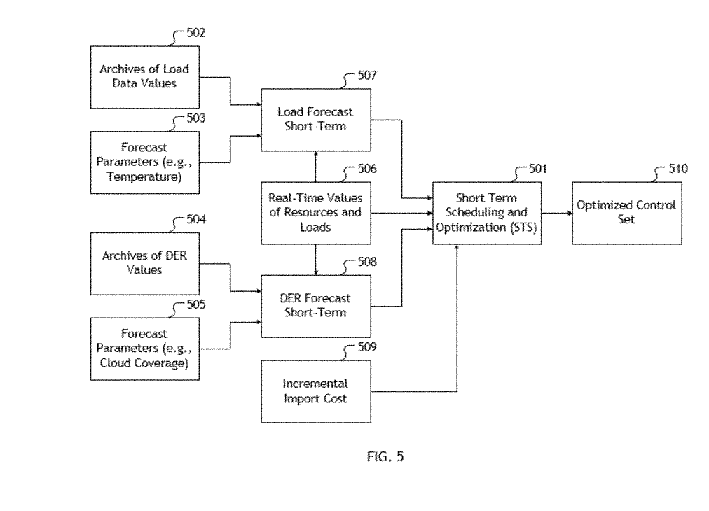

Referring to FIG. 5, which is a flow chart illustrating an example of the general process by which the systems and methods apply the incremental cost of import in a particular embodiment of the described invention, Archives of Load Data Values [502] and Load Forecast Parameters [503] commonly known in the industry together with Real-time value of Load are utilized to determine a Load Forecast Short-Term [507]. Archives of Renewable Data Values [504] and Renewable Forecast Parameters [505] commonly known in the industry together with Real-time value of renewable resources are utilized to determine the Renewable Short-Term Forecasts [508]. Depending on the embodiment, the Real-Time Values of Resources and Loads [506], the Load Forecast Short-Term [507], the short term renewable Forecasts [508], Incremental Import Cost [509], or a combination thereof may be used to conduct Short Term Scheduling and Optimization (STS) [501]. Conduct STS continuously once per interval using the costs determined by Import Cost Constraints [401]. Deploy set point controls in the next interval as an Optimized Control Set [510].

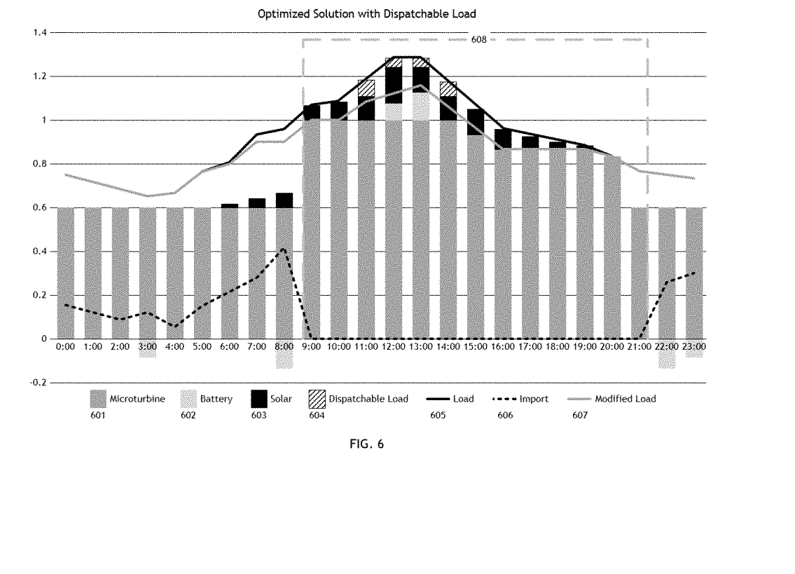

Referring to FIG. 6, which is a bar graph depicting the results of a microgrid usecase describing the general process by which the systems and methods may utilize the day-ahead load and renewable forecast profile along with other data to determine a demand charge curve, the invention utilizes the forecast day-ahead load profile along with other data to determine an incremental demand charge curve which combines energy and demand charge at different load levels. During a high load demand period, the proposed invention is capable of recognizing the higher demand charge and defining appropriate utility charges for optimization. Equipped with appropriately calculated energy and demand user charges, the invention examines the load profile inputs, and other generation and load source characteristics as defined for a load consuming area to optimize system operation, such as but not limited to, a microgrid. The incremental import cost calculated may be utilized to perform peak shaving irrespective of the duration of each interval or total number of intervals. In some embodiments, while using this model the system can facilitate the modification of the charging and discharging price of batteries such that they charge when the bulk electric system import price for electricity is less and discharge when it is high.

In one non-limiting example, if the microgrid includes a battery or other storage energy resource, the invention may advise or take action, depending on various embodiments, to discharge the battery charge prior to utilizing high demand charge imports or other more expensive resources. In another non-limiting example, if the load profile includes a solar input or other variable energy resource, the invention may determine utilization of these resources as economically or otherwise advantageous when forecasted to be available in sufficient quantities. In some embodiments, the systems and methods of the proposed invention may incorporate factors other than economic optimization, such as but not limited to, user preference for solar power usage, into the load profile ultimately optimizing resources usage including import from the utility for a user's preference.

Conversely, in another non-limiting example, the invention may analyze load profile inputs, including power grid inputs and other generation and load sources for a load consuming area, in order to determine an economically advantageous time segment in which to charge a battery or other stored energy resource, such as the early morning hours, when energy prices tend to lower, or during a period of lower than expected usage when utility energy prices can become low. In this way, the system and methods of the proposed invention may anticipate future energy needs and prepare accordingly by storing lower cost energy for future use.

FIG. 6 shows that in this usecase, the microgrid charges the storage during the low cost period and uses utility import to balance generation with load. On the other hand, during the peak period, the storage is discharged and other resources such as the micro-turbine and dispatchable load are used to avoid using the import with high demand charge costs resulting in the total optimization of microgrid operation using all resources including the utility import considering its actual incremental cost including the energy and demand charge.

As a non-limiting example, in certain embodiments, the invention may comprise of computer software located on a participant 202, 300, 400 device, which may act as data publishing sources, or from any other data publishing source, such as although not necessarily limited to, a computer, tablet, or mobile device utilized to send messages and data transmissions to facilitate the system and methods herein described.

1. A method for resource optimization solution for microgrid, configured to:
a. estimate forecasted load demanded by the microgrid as a day-ahead import schedule;
b. Establish an incremental cost of import;
c. determine applicability of incremental cost of import using import cost constraints; and
d. apply the incremental cost of import in short term scheduling and optimization

2. The method of claim 1, wherein the day-ahead import schedule is comprised of:
a. Real-Time Values of Resources and Loads;
b. Day-Ahead Load Forecast;
c. Day-Ahead DER Forecast; and
d. Using Import Cost without Demand Charge;

3. The method of claim 1, wherein the incremental cost of import is comprised of:
a. Demand charge comprised of:
i. Demand Charge Incremental Cost comprised of:
1. Day-Ahead Schedule divided into segments comprised of:
a. Day-Ahead Import Schedule

4. The method of claim 1, wherein the import cost constraints are comprised of:
a. An import cost configured to:
i. Use Energy cost when a Peak Demand measured in the current period is less than the Import Level from the expected historical data;
ii. Compare against the Highest Peak Demand during the month so far when a Peak Demand measured in the current period is greater than the Import Level from the expected historical data
iii. Use Energy cost when a Peak Demand measured in the current period is less than the Highest Peak Demand during the month so far;
iv. Use Incremental Cost of Import when a Peak Demand measured in the current period is greater than the Highest Peak Demand during the month so far

5. The method of claim 1, wherein the incremental cost of import is comprised of:
a. Real-Time Values of Resources and Loads;
b. Load Forecast Short-Term;
c. DER Forecast Short-Term;
d. Using Incremental Import Cost including Demand Charge; and
e. Deployed in the next interval as an Optimized Control Set;

6. A system for resource optimization solution for microgrid, configured to:
a. estimate forecasted load demanded by the microgrid as a day-ahead import schedule;
b. Establish an incremental cost of import;
c. determine applicability of incremental cost of import using import cost constraints; and
d. apply the incremental cost of import in short term scheduling and optimization

7. The system of claim 6, wherein the day-ahead import schedule is comprised of:
a. Real-Time Values of Resources and Loads;
b. Day-Ahead Load Forecast;
c. Day-Ahead DER Forecast; and
d. Using Import Cost without Demand Charge;

8. The system of claim 6, wherein the incremental cost of import is comprised of:
a. Demand charge comprised of:
i. Demand Charge Incremental Cost comprised of:
1. Day-Ahead Schedule divided into segments comprised of:
a. Day-Ahead Import Schedule

9. The system of claim 6, wherein the import cost constraints are comprised of:
a. An import cost configured to:
i. Use Energy cost when a Peak Demand measured in the current period is less than the Import Level from the expected historical data;
ii. Compare against the Highest Peak Demand during the month so far when a Peak Demand measured in the current period is greater than the Import Level from the expected historical data;
iii. Use Energy cost when a Peak Demand measured in the current period is less than the Highest Peak Demand during the month so far;
iv. Use Incremental Cost of Import when a Peak Demand measured in the current period is greater than the Highest Peak Demand during the month so far;

10. The system of claim 6, wherein the incremental cost of import is comprised of:
a. Real-Time Values of Resources and Loads;
b. Load Forecast Short-Term;
c. DER Forecast Short-Term;
d. Using Incremental Import Cost including Demand Charge; and
e. Deployed in the next interval as an Optimized Control Set;
